(19) United States
(12) Patent Application Publication
(10) Pub. No.: US 2006/0160541 A1
(43) Pub. Date: Jul. 20, 2006

(54) Method of GSM cell reselection

(75) Inventor: Dong-Won Ryu, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/288,560

(22) Filed: Nov. 29, 2005

(30) Foreign Application Priority Data
Jan. 18, 2005 (KR) 10-2005-0004684

(51) Int. Cl. H04Q 7/20

(52) U.S. Cl. 455/446

(57) ABSTRACT

Disclosed is a method for cell reselection in a global system for mobile communication, the method including measuring reception powers and reception qualities of signals provided from a current serving cell and neighboring cells; finding a cell corresponding to a predetermined criterion from among the neighboring cells by comparing the measured reception powers and reception qualities of the current serving cell and the neighboring cells; and performing cell reselection to a relevant cell when the relevant cell corresponding to the predetermined criterion is found.

### PRIORITY

This application claims to the benefit under 35 U.S.C. 119(a) of an application entitled “Method of GSM Cell Re-selection” filed in the Korean Intellectual Property Office on Jan. 18, 2005 and assigned Serial No. 2005-4684, the entire contents of which are incorporated herein by reference.

### BACKGROUND OF THE INVENTION

1. Field of the Invention

The present invention relates to cell reselection by a mobile station in a cellular radio system, and more particularly, to a cell reselection method suitable for GSM/GPRS (Global System for Mobile communication/General Packet Radio Service) mobile stations.

2. Description of the Related Art

Global System for Mobile communications (GSM) is a digital mobile telephone system, which is a type of cellular system. The GSM scheme is employed extensively in many areas including Europe. A General Packet Radio Service (GPRS) developed on the basis of the GSM system is a more advanced packet-based mobile communication service.

In the GSM system, each base station transmits a signal through a Broadcast Control CHannel (BCCH) assigned a different frequency from those of neighboring base stations, and each mobile station measures the intensities of received BCCH signals and determines the most desirable cell with the best quality radio connection on the basis of the measured intensities. The base stations also transmit information relating to BCCH frequencies used in neighboring cells so that the mobile stations know the used frequencies to receive the BCCH signals of neighboring cells. A BCCH signal transmitted in each cell includes information about how the mobile stations can send a so-called random access request in each cell to accomplish a call connection.

A mobile station typically moves with a cell or tries to select a base station on which the mobile station camps. The first step for a cell to camp in an idle mode is to enable the mobile station to receive system information from a Public Land Mobile Network (PLMN). The second step is to make it possible to establish a wireless connection, by causing the mobile station to initially access the network through a control channel of the camped-on cell in registration or in radio connection establishment. The third step is to enable the PLMN to detect the registration area of the camped-on cell of a registered mobile station when the PLMN receives a call for the registered mobile station, and to enable the PLMN to send a paging message for the mobile station to the control channels of all cells included in the registration area. As a result, the mobile station can receive a paging message through the control channel of a cell in the registration area, and respond via the corresponding control channel. In addition, it is possible for the mobile station to receive a cell broadcast service. In other words, the mobile station camps on a base station of a neighboring cell and receives service from the relevant base station.

Inevitably, a change in a cell or between cells occurs because of movement of the mobile station. As a result, cell reselection is required. According to cell reselection, first, the mobile station measures reception powers of neighboring cell signals when it fails to receive service from its serving cell when idle. Then, the mobile station checks whether the reception powers from neighboring cells are equal to or larger than a predetermined reference value, finds a reception power equal to or larger than the predetermined reference value, and camps on the cell with sufficient reception power, i.e., greater than the predetermined reference value.

However, the above cell reselection is performed using only reception powers from all cells without considering their reception qualities. Therefore, this cell reselection scheme fails to reflect the case in which reception power is low while actual reception quality is good. As a result, a cell which provides a signal having a large reception power but poor reception quality may be selected. When that happens, and a mobile originated (MO) call is attempted, it is difficult to normally decode a signaling channel, so cell set-up time increases from redialing or the call fails.

### SUMMARY OF THE INVENTION

Accordingly, the present invention has been made to solve the above-mentioned problems occurring in the prior art, and an object of the present invention is to provide a cell reselection method capable of performing an optimum cell reselection in a global system for mobile communication.

Another object of the present invention is to provide a cell reselection method that considers reception signal quality in a global system for mobile communication.

To accomplish these objects, in accordance with one aspect of the present invention, there is provided a method for cell reselection in a global system for mobile communication, the method including measuring reception powers and reception qualities of signals provided from a current serving cell and neighboring cells; finding a cell corresponding to a predetermined criterion from among the neighboring cells by comparing the measured reception powers and reception qualities of the current serving cell and the neighboring cells; and performing cell reselection to a relevant cell when the relevant cell corresponding to the predetermined criterion is found.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram schematically illustrating a basic construction of a cellular radio system according to an embodiment of the present invention;

FIG. 2A is a diagram illustrating a service application area in the cellular radio system of FIG. 1;

FIG. 2B is a diagram illustrating a cell construction in the service application area of FIG. 2A;

FIG. 3 is a block diagram schematically illustrating mobile station according to an embodiment of the present invention; and

FIG. 4 is a flowchart illustrating a cell reselection operation according to an embodiment of the present invention.

### DETAILED DESCRIPTION OF THE PREFERRED EMBODIMENT

Hereinafter, one preferred embodiment according to the present invention will be described with reference to the accompanying drawings. In the below description, many particular items such as a detailed component device are shown, but are only provided to aid in the general understanding of the present invention. It will be understood by those skilled in the art that the present invention can be embodied without some of the particular items discussed below. In the following description, a detailed description of known functions and configurations incorporated herein will be omitted when it may obscure the subject matter of the present invention.

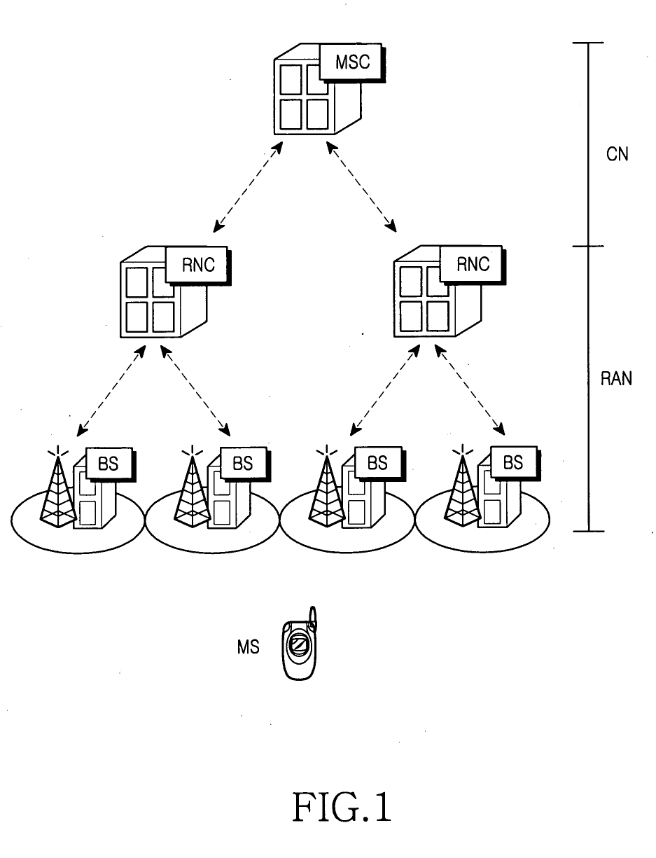

FIG. 1 is a diagram illustrating the basic construction of a digital cellular system. Typically, a mobile communication network includes at least one Core Network (CN) and at least one Radio Access Network (RAN). The CN includes various central networks capable of providing a variety of intelligent networks in addition to various communication means. The CN includes a Mobile service Switching Center (MSC) [e.g., a serving GPRS support node (SGSN) of providing service in a GSM (Global System for Mobile communication)], other network elements, and a related transmission system. The RAN is located between the CN and a mobile station. The RAN includes a Base Transceiver Station (BTS) and a radio network controller (RNC). Each Base Station (BS) is fixedly connected to the RNC. At least one RAN can operate between a Mobile Station (MS) and a CN, and the mobile station can access the CN through a predetermined RAN.

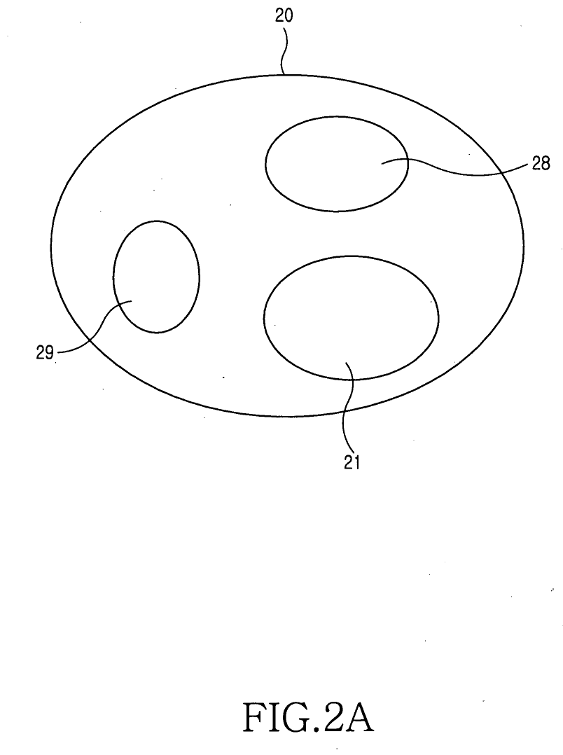

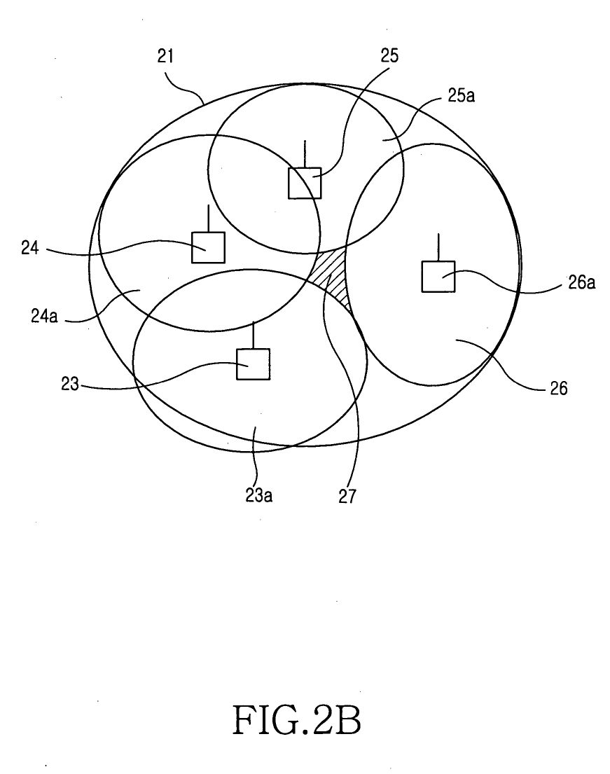

FIG. 2A is a diagram illustrating a service application area to which service is provided by a cellular system. Reference numeral 20 indicates an area representing a basic GSM service application range, and sub-areas 21, 28 and 29 represents GPRS application ranges. Typically, each sub-area may be a city, an airport or a particular piece of land.

FIG. 2B is a detailed diagram illustrating the sub-area 21 which contains GPRS base stations 23, 24, 25 and 26. Although a basic service GSM base station is not shown in FIG. 2B, the sub-area 21 is contained in the basic GSM service application range. In addition, FIG. 2B shows that even the GPRS application area may contain a region 27 out of the coverage of the GPRS base stations. A mobile station located in the region 27 can be connected to the GSM base station only which provides basic GSM service. In addition, it is noted from FIG. 2B that, when a mobile station moves within a considerably small base station coverage, the base station from which the mobile station is currently receiving service changes within a short time interval.

In a cellular radio system, mobile stations select a base station coverage, on which the mobile station camps, to receive proper radio connection quality. Conventionally, cell selection is based on a received radio signal level measured in the mobile station or in one of the base stations. For instance, in the GSM system, each base station transmits a signal on the broadcast control channel (BCCH) that has a different frequency from those of neighboring base stations. The mobile station measures the intensities of received BCCH signals, and determine the most efficient cell in terms of radio connection quality based on the measured signal intensities. The base station informs the mobile station of BCCH frequencies used in neighboring cells so that the mobile station can use the frequencies to receive BCCH signals from the neighboring cells. In addition, in each cell, a transmitted BCCH signal includes information about how the mobile station can send a so-called random access request to a specific cell to establish a connection.

While the mobile station is camping on a cell, it periodically measures signal intensities of its own and neighboring cells. Preferably, the neighboring cells are checked according to a neighboring channel list broadcasted by its serving cell. The mobile station tries to find a cell having the best available pilot and determines whether cell reselection is necessary based on cell reselection criterion.

Preferably, cell selection and cell reselection are performed on the basis of a path loss criterion parameter (C1) and a reselection criterion parameter (C2). The path loss criterion is used to determine whether or not the mobile station can communicate with a network without interference, that is, whether or not the mobile station has been properly located within the coverage of the cell in question. The reselection criterion is used to determine the relative superiority levels of candidate cells to find the best available cell. The reselection criterion is determined by using the pass loss criterion (C1) and a cell priority ‘CELL_RESELECT_OFFSET’ assigned by a network.

The path loss criterion (C1) is determined by a transmission power and the measured intensity of a reception signal through a signaling channel for a specific cell, which is received through an antenna connector of the mobile station. The path loss criterion (C1) is defined by Equation (1) below and is calculated by the mobile station. In addition, the cell reselection criterion (C2) is conventionally defined by Equation (1) as well. In this case, cell hysteresis and limited time for reselection are employed to avoid a ping-pong phenomenon of cell reselection in a cell boundary area which belongs to multiple LACs (Location Area Codes) different from each other.
C1=(RXLEV−RXLEV_ACCESS_MIN)−Max[MS_{—}TXPWR_MAX_{—}CCH−P, 0]
Serving Cell: C2=C1+CELL_RESELECT_OFFSET
Neighboring Cell: C2=C1−CELL_RESELECT_OFFSET−TEMPORARY_OFFSET*H(PENALTY_TIME−T)
H(x)=0 for x<0
H(x)=1 for x≧0 (1)

Herein, the ‘CELL_RESELECT_OFFSET’ represents a cell reselection parameter prescribed in the GSM standard 05.08, which may be a positive or negative number because cell reselection may accelerate (CELL_RESELECT_OFFSET<0) or may be limited (CELL_RESELECT_OFFSET>0) depending on the value of the parameter. Generally, the ‘CELL_RESELECT_OFFSET’ and the ‘TEMPORARY_OFFSET’ are delivered to the mobile station through ‘System Information (SI) 3’ which is usual system information.

As described above, the conventional cell reselection scheme is performed using only reception powers with respect to signals from all cells without considering their actual reception qualities, so that the conventional cell reselection scheme fails to reflect the case where reception power is low while actual reception quality is good. According to an embodiment of the present invention, the mobile station can find a cell that enables communication with a base station, by considering both reception power and reception quality.

According to an embodiment of the present invention, a value for reflecting the reception quality of a radio channel is added to the conventional cell reselection algorithm for calculating the value of the C2. The added value is a ratio of a pilot energy accumulated during a predetermined time period to the total power spectrum density of a received bandwidth (Ec/No). Therefore, when a GSM terminal calculates the value of C2 for its serving cell, the GSM terminal reflects information about a signal-to-noise ratio (SNR) [dBm] and a power level [dBm] of the serving cell, which are contained in GSM L1 burst metrics, in an idle mode. In the case of calculating the value of C2 for a neighboring cell, the reception power and the reception quality of the neighboring cell in ‘GSM L1 Neighbor Cell BCCH Burst Metrics’ are reflected. According to an embodiment of the present invention, the cell reselection criterion (C2) is defined by Equation (2):
Serving Cell: C2=C1+CELL_RESELECT_OFFSET+SNRs
Neighboring Cell: C2=C1−CELL_RESELECT_OFFSET+SNRn−TEMPORARY_OFFSET*H(PENALTY_TIME−T)
H(x)=0 for x<0
H(x)=1 for x≧0 (2)

Herein, ‘SNRs’ is SNR information of the current serving cell, and ‘SNRn’ is SNR information of a neighboring cell.

As shown in Equation (3) below, when a neighboring cell has a larger C2 value than the serving cell during a predetermined time period, cell reselection is performed.

1. When the serving cell [C2] and a neighboring cell [C2] belong to the same LAC:
[Neighboring Cell: C2]>[Serving Cell: C2] for 5 [sec]

2. When the serving cell [C2] and a neighboring cell [C2] belong to different LACs from each other:
[Neighboring Cell: C2]>[Serving Cell: C2]+CELL_RESELECT_HYSTERESIS for 5 [sec] (3)

Herein, the ‘CELL_RESELECT_HYSTERESIS’ represents a cell reselection hysteresis value for preventing frequent performance of the cell reselection operation. That is, the ‘CELL_RESELECT_HYSTERESIS’ is a value set to avoid a ping-pong phenomenon of cell reselection in a region where LAC actually changes. Cell reselection to a neighboring cell that belongs to a different LAC is performed when the C2 value of the neighboring cell is larger than that of the current serving cell by at least the parameter contained in ‘CELL_RESELECT_HYSTERESIS’. In this case, this parameter is delivered to the mobile station through ‘System Information (SI) 3’, which is system information.

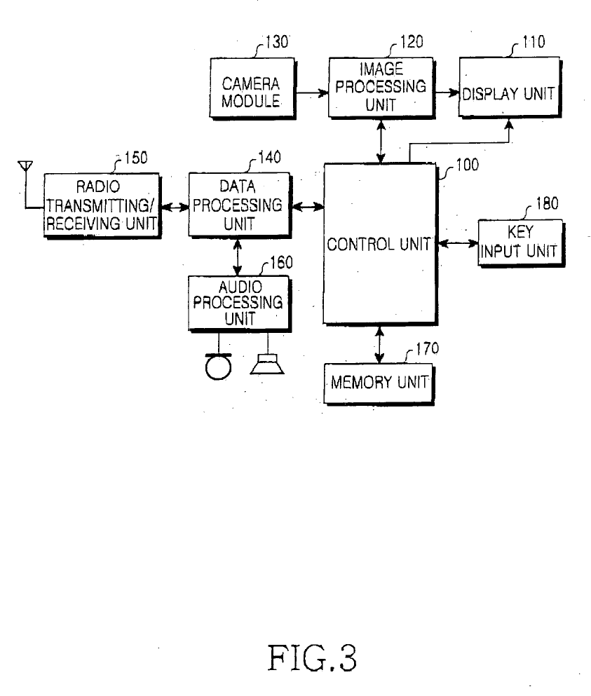

FIG. 3 is a block diagram schematically illustrating a GSM terminal (i.e., a mobile station) to which the present invention may be applied. A radio transmitting/receiving unit 150 receives a frequency signal, which is transmitted through a radio channel of a frequency band, via an antenna under the control of a control unit 100. A data processing unit 140 down-converts the band of the frequency signal received through the radio transmitting/receiving unit 150, and then outputs the down-converted signal to the control unit 100 according to the data type. The data output from the radio transmitting/receiving 150 to the control unit 100 include character data, a paging signal received through a paging channel, and a signaling signal.

A key input unit 180 includes multiple numeric keys and function keys for performing various functions, and outputs an electrical signal corresponding to data of a pressed key to the control unit 100 according to keys pressed by the user. An audio processing unit 160 generally includes a vocoder and operates under the control of the control unit 100. The audio processing unit 160 decodes encoded voice data received from the radio transmitting/receiving unit 150 to convert the encoded voice data into an electrical voice signal, and then outputs the electrical voice signal to a speaker. Then, the speaker converts the electrical voice signal into an audible sound and outputs the audible sound. Also, the audio processing unit 160 encodes an electrical voice signal received from a microphone and then outputs the encoded voice signal to the radio transmitting/receiving unit 150.

A camera module 130 includes a camera sensor and a signal processing section. The camera sensor photographs an image and converts a light signal obtained from the photographing into an electric signal. The signal processing section converts an analog image signal from the photographing into digital data.

An image processing unit 120 generates screen data for displaying an image for an image signal output from the camera module 130 to the display unit 110. A memory unit 170 includes a ROM for storing an operation program, an electrically programmable EEPROM, a RAM, and the like in terms of hardware. Also, the memory unit 170 may include a program memory and a data memory in terms of logic, which store various information required for controlling the operation of the mobile station.

The control unit 100 controls the respective function units and operations of the mobile station, and in particular, controls the cell reselection operation.

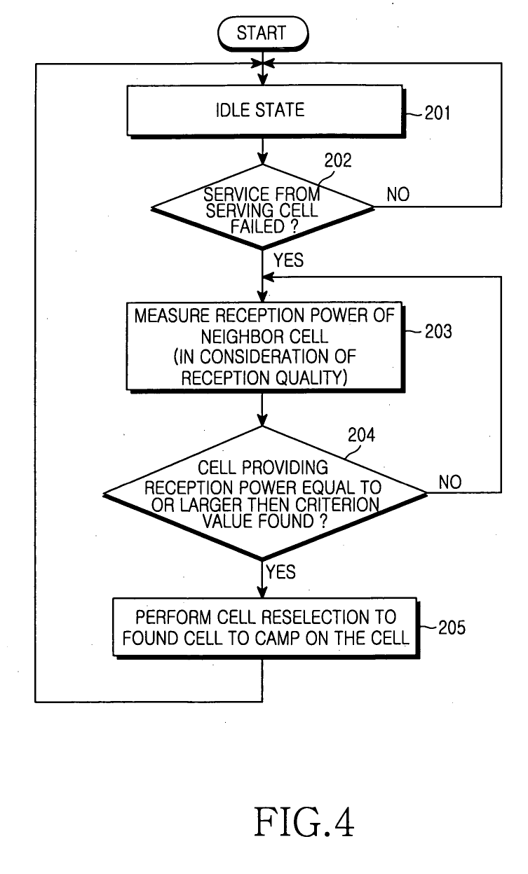

FIG. 4 is a flowchart illustrating cell reselection according to an embodiment of the present invention. First, when the mobile station fails to receive a service from its serving cell in an idle mode at step 201, such a failure is determined in step 202 and then the procedure proceeds to step 203. If there is no failure at step 202, the terminal remains in the idle state at step 201. In step 203, reception powers of the current serving cell and neighboring cells are measured in consideration of their reception qualities by Equation (2). In step 204, the measured reception power of each neighboring cell is compared to a predetermined reference value by Equation (3). When a neighboring cell providing a reception power equal to or larger than the predetermined reference value is found, cell reselection is done to camp on the relevant cell at step 205.

As described above, since cell reselection is performed considering radio channel quality, it is possible to prevent failure of downlink signaling in an idle state where reception power is large and a SNR is poor. In addition, since a cell providing good channel quality is selected by the cell reselection method, it is possible to prevent call failure due to abnormal decoding of a signaling channel and to prevent the increase of a call set-up time due to repeated redialing, when a mobile originated (MO) call is attempted in the above case. Particularly, when the mobile station moves while the GPRS is connecting a packet service data call, a new cell is found by cell reselection. In this case, since the cell reselection according to an embodiment of the present invention is performed considering both reception power and reception quality, it is possible to find a relatively better cell.

As described above, the cell reselection operation according to an embodiment of the present invention can be accomplished in a GSM terminal. While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for cell reselection in a Global System for Mobile communication, the method comprising the steps of:
measuring reception powers and reception qualities of signals provided from a current serving cell and neighboring cells;
finding a relevant cell corresponding to a predetermined criterion from among the neighboring cells by comparing the measured reception powers and reception qualities of the current serving cell and the neighboring cells; and
performing cell reselection to the relevant cell.

2. The method as claimed in claim 1, wherein, in the measuring step, the reception powers and reception qualities of signals provided from the current serving cell and the neighboring cells are measured according to,
Serving Cell: C2=C1+CELL_RESELECT_OFFSET+SNRs
Neighboring Cell: C2=C1−CELL_RESELECT_OFFSET+SNRn−TEMPORARY_OFFSET*H(PENALTY_TIME−T)
H(x)=0 for x<0
H(x)=1 for x≧0,
wherein ‘C1’ is a path loss criterion parameter, ‘SNRs’ is an SNR (Signal to Noise Ratio, dBm) value of the current serving cell, and ‘SNRn’ is an SNR value of a neighboring cell.

3. The method as claimed in claim 2, wherein, in the finding step, a cell corresponding to a predetermined criterion is found from among the neighboring cells based on,
a. When the serving cell [C2] and a neighboring cell [C2] belong to the same LAC:
[Neighboring Cell: C2]>[Serving Cell: C2] for 5 [sec]
b. When the serving cell [C2] and a neighboring cell [C2] belong to different LACs from each other:
[Neighboring Cell: C2]>[Serving Cell: C2]+CELL_RESELECT_HYSTERESIS for 5 [sec],
wherein the ‘CELL_RESELECT_HYSTERESIS’ represents a cell reselection hysteresis value.
